(19) United States
(12) Patent Application Publication
(10) Pub. No.: US 2008/0047276 A1
(43) Pub. Date: Feb. 28, 2008

(54) Combustion turbine having a single compressor with inter-cooling between stages

(75) Inventors: Joan M. Baer, Casselberry, FL (US); Nathan R. Pfeifer, Winter Park, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/510,242

(22) Filed: Aug. 25, 2006

(51) Int. Cl. F02C 6/04

(52) U.S. Cl. 60/785; 60/728

(57) ABSTRACT

A combustion turbine is disclosed having a single shaft compressor that includes a low pressure side and a high pressure side. The compressor operation is optimized by inter-cooling within the compressor. In particular, a compressed fluid is extracted from a selected stage and the extracted fluid is cooled and returned to a selected stage within the compressor. The compressor inter-cooling improves engine performance and cycle performance, as measured by an increase in power or a decrease in heat rate for the same power.

### FIELD OF THE INVENTION

This invention is directed generally to combustion turbines, and more particularly to combustion turbines having a single compressor, wherein compressed fluid, such as air, is extracted from one or more selected stages within the compressor, the extracted compressed fluid is cooled and returned to one or more selected stage within the compressor.

### BACKGROUND

Combustion turbines are generally employed in power generation plants. Typically, combustion turbines include three main components: a compressor for compressing a fluid, such as air; a combustor for mixing the compressed fluid with fuel and igniting the mixture; and a turbine for producing power. These components are generally configured in series and are sealed to form a gas-tight system.

The compressor and turbine components typically contain many rows of opposing airfoil-shaped blades that are grouped in stages. In the compressor component, the stages typically include a row of rotating blades (rotors) followed by a row of stationary blades (stators), as viewed from a direction of fluid flow from an inlet side to an outlet side. In the turbine component, the stages typically include a row of stationary blades (vanes) followed by a row of rotating blades (blades), as viewed in a direction of fluid flow from an inlet side to an outlet side. The combustor component is located between the compressor component and the turbine component. The combustor component generally operates at high temperatures, which may exceed 2,500 degrees Fahrenheit.

The stages within the compressor component and the turbine component are configured in series and each contributes to a pressure rise in the compressor component and a pressure drop in the turbine component. The rotating blade rows are coupled to a shaft that runs through the compressor component to the turbine component. The stationary blade rows are typically coupled to an interior periphery of the corresponding compressor and turbine components.

The compressor component is configured to include a funnel-shaped structure or annulus that reduces a volume available to an air mass that travels from the inlet side to the outlet side. The compressor component receives ambient air at the inlet side. The blades within the compressor component transfer mechanical energy into the flow through aerodynamic lift and force the air mass through the annulus. The blade and vane airfoils diffuse the fluid flow to higher pressures thus compressing and heating the air mass. The compressor component ejects the compressed air mass into the combustor component. In the combustor component, fuel is injected into the compressed air stream and ignited. The burning fuel causes the fuel/compressed air mass mixture to rise significantly in temperature. The heated flow travels through the turbine where it expands back toward ambient conditions. The turbine component is configured to include a reverse funnel-shaped structure that increases a volume available to an air mass that travels from the inlet side to the outlet side. The air mass travels through the turbine and, again, aerodynamic lift causes the turbine blades to spin, allowing the airfoils to extract mechanical energy from the fluid flow. The air mass expands as it pushes through the turbine component. The turbine blades spin the shaft coupled thereto. One or more shafts run between the turbine component and the compressor component. As a result, the spinning shaft drives both the compressor blades and a generator, or other load of the combustion turbine.

While advances have been made in increasing the efficiency of combustion turbines, a need still exists for increasing engine performance and cycle performance of combustion turbines. Conventional systems have relied on multiple series connected compressors and/or multiple series connected turbine sections to increase efficiency. However, these conventional systems include several drawbacks.

### SUMMARY OF THE INVENTION

Various aspects of the invention overcome at least some of these and other drawbacks of existing systems. According to one embodiment of the invention, a compressor is provided for a combustion turbine that include a low pressure structure having a plurality of stages and a high pressure structure having a plurality of stages, wherein the low pressure structure and the high pressure structure are coupled to the same shaft. The low pressure structure and the high pressure structure are enclosed in a compressor structure. An intercooler is fluidly coupled to the compressor structure, with the intercooler being positioned between the low pressure structure and the high pressure structure. The intercooler includes an inlet that extracts fluid from at least one stage within the low pressure structure and an outlet that returns cooled fluid to at least one stage within the high pressure structure. The intercooler may include a heat exchanger, among other coolers.

According to one embodiment of the invention, the compressor intercooler may be configured to maintain a pressure drop equal to or less than 5 pounds per square inch. According to another embodiment of the invention, the compressor intercooler may be configured to extract from the compressor substantially all of the total compressor air flow. According to another embodiment of the invention, the compressor intercooler may be configured to extract from the compressor up to 20% by volume of the total compressor air flow. According to one embodiment of the invention, the compressor intercooler may introduce the cooled fluid into the compressor at a temperature that is at least 25% cooler than the fluid extracted from the compressor. The compressor intercooler provides the compressor with higher performance by reducing the work needed to run the compressor.

According to another embodiment of the invention, a combustion turbine includes a compressor, combustor and turbine that are configured in series and include a singe shaft coupling the compressor and turbine. The compressor includes a low pressure structure having a plurality of stages and a high pressure structure having a plurality of stages, wherein the low pressure structure and the high pressure structure are coupled to the same shaft. The low pressure structure and the high pressure structure are enclosed in a compressor structure. An intercooler is fluidly coupled to the compressor structure, with the intercooler being positioned between the low pressure structure and the high pressure structure. The intercooler includes an inlet that extracts fluid from at least one stage within the low pressure structure and an outlet that returns cooled fluid to at least one stage within the high pressure structure. The intercooler may include a heat exchanger, among other coolers.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 illustrates a combustion turbine according to one embodiment of the invention.

FIG. 2 illustrates an Enthalpy/Temperature v. Entropy graph according to one embodiment of the invention.

### DETAILED DESCRIPTION OF THE INVENTION

While specific embodiments of the invention are discussed herein and are illustrated in the drawings appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

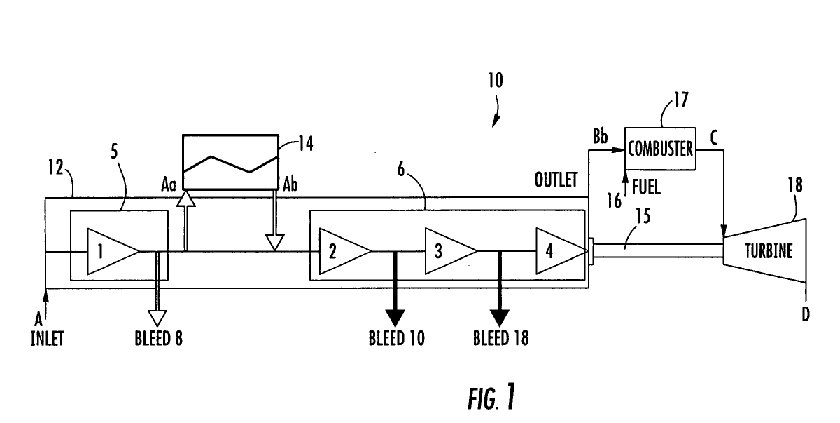

According to one embodiment of the invention illustrated in FIG. 1, a gas turbine 10 or internal combustion (IC) engine is provided. According to one embodiment of the invention, the gas turbine 10 may employ a continuous combustion process. The gas turbine 10 may include a compressor 12 having a low pressure side 5 including a structure 1 having a plurality of stages, a high pressure side 6 including structures 2,3,4 having a plurality of stages and a compressor intercooler 14 that is fluidly coupled between the low pressure side 5 and the high pressure side 6. According to one embodiment of the invention, the low pressure side 5 may include at least six stages. According to one embodiment of the invention, the high pressure side 6 may include at least nine stages. According to another embodiment of the invention, the low pressure side 5 may include less than ten stages. According to one embodiment of the invention, the high pressure side 6 may include less than ten stages. One of ordinary skill in the art will readily appreciate that any number of stage may be employed in the low pressure side 5 and/or the high pressure side 6.

According to one embodiment of the invention, the compressor 12 may include a single shaft that is coupled to components of the low pressure side 5 and to components of the high pressure side 6 of compressor 12. Structures 1-4 perform the function of compressing the fluid that passes through compressor 12. According to one embodiment of the invention, a bleed line 8 may be provided after the low pressure side 5 side of compressor 12 to supply cooling fluid to a rear of the turbine 18. According to one embodiment of the invention, a bleed line 10 may be provided between structures 2 and 3 to supply cooling fluid to a mid-stage of the turbine 18. According to one embodiment of the invention, a bleed line 18 may be provided after the structure 4 to supply cooling fluid to a front of the turbine 18.

According to one embodiment of the invention, the compressor intercooler 14 may include a heat exchanger or other intercooler that extracts the compressed fluid, such as air or other compressed fluid, from the gas turbine 10 at one or more selected stages within the compressor 12. According to another embodiment of the invention, the compressor intercooler 14 cools the compressed fluid using a cooling fluid, such atmospheric air, water, or other cooling fluid and reintroduces the cooled compressed fluid into the gas turbine 10 at one or more selected stages within the compressor 12. According to one embodiment of the invention, the compressor intercooler 14 may extract the compressed fluid after a sixth stage of the compressor 12 and may reintroduce the cooled compressed fluid before the seventh stage of the compressor 12. According to another embodiment of the invention, the compressor intercooler 14 may extract the compressed fluid after a low pressure side 5 of the compressor 12 and may reintroduce the cooled compressed fluid before the high pressure side 6 of the compressor 12. According to one embodiment of the invention, the compressed fluid may be extracted from the compressor 12 after approximately 50% completion of the compression process. One of ordinary skill in the art will readily appreciate that the compressor intercooler 14 may extract the compressed fluid from any stage of the compressor 12 and may reintroduce the compressed fluid into any stage of the compressor 12.

According to one embodiment of the invention, the compressor intercooler 14 returns the cooled compressed fluid to one or more stages of the compressor 12 that are located at a same stage and/or at a closer stage to the outlet side of the compressor 12, compared to the one or more stages of the compressor 12 from which the compressed fluid is extracted. According to one embodiment of the invention, the compressor intercooler 14 may cool the extracted fluid by approximately 200 degrees Fahrenheit before reintroducing the cooled fluid into the compressor 12. According to another embodiment of the invention, the compressor intercooler 14 may introduce the cooled fluid into the compressor 12 at a temperature that is at least 40% cooler than the extracted fluid. According to another embodiment of the invention, the compressor intercooler 14 may introduce the cooled fluid into the compressor 12 at a temperature that is at least 25% cooler than the extracted fluid. One of ordinary skill in the art will readily appreciate that other amounts of cooling may be provided by the compressor intercooler 14.

According to one embodiment of the invention, the compressor intercooler 14 may be configured to maintain a pressure drop equal to or less than approximately 5 pounds per square inch (psi). According to one embodiment of the invention, the compressor intercooler 14 may be configured to maintain a pressure drop equal to or less than approximately 3.5 psi. One of ordinary skill in the art will readily appreciate that other amounts of pressure drop may be designed into the intercooler 14. Intercooler pressure losses may be mitigated by decelerating the extracted flow to lower velocities with an exit diffuser, thereby reducing the dynamic losses in intercooler components, such as piping and the heat exchanger. According to another embodiment of the invention, one or more stages of the compressor 12 that are located downstream of the return stage (e.g., closer to the outlet side of the compressor 12) may be designed to compensate for any pressure drop that is introduced by intercooler 14.

According to one embodiment of the invention, the compressor intercooler 14 may be configured to extract substantially all of the compressor air flow from the compressor 12, without causing an adverse pressure drop in the compressor 12. According to another embodiment of the invention, the compressor intercooler 14 may be configured to extract up to approximately 80% by volume of the total compressor air flow from the compressor 12, without causing an adverse pressure drop in the compressor 12. According to another embodiment of the invention, the compressor intercooler 14 may be configured to extract up to approximately 40% by volume of the total compressor air flow from the compressor 12, without causing an adverse pressure drop in the compressor 12. According to yet another embodiment of the invention, the compressor intercooler 14 may be configured to extract up to approximately 20% by volume of the total compressor air flow from the compressor 12, without causing an adverse pressure drop in the compressor 12. According to one embodiment of the invention, the configuration of down stream blades may be designed to compensate for a reduced mass flow rate. One of ordinary skill in the art will readily appreciate that other volumes of compressed air flow may be extracted from the compressor 12 without causing an adverse pressure drop in the compressor 12.

According to one embodiment of the invention, the compressor 12 includes an outlet that provides a compressed air flow to combustor 17. According to one embodiment of the invention, the compressed air flow may have an exit temperature of several hundred degrees Fahrenheit at the outlet to compressor 12. According to another embodiment of the invention, the compressed air flow may have an exit temperature of several hundred degrees Fahrenheit at the outlet to compressor 12. According to another embodiment of the invention, the compressed air flow may have an exit temperature of approximately 500 degrees Fahrenheit or higher at the outlet to compressor 12. According to another embodiment of the invention, the compressed air flow may have an exit temperature of approximately 750 degrees Fahrenheit or higher at the outlet to compressor 12.

According to one embodiment of the invention, the combustor 17 receives the compressed air flow and injects fuel 16 into the compressed air flow. The compressed air flow/fuel mixture is ignited to increase the air mass temperature to over 2000 degrees Fahrenheit. According to one embodiment of the invention, the air flow/fuel mixture is ignited on a continuous basis.

According to one embodiment of the invention, the heated and compressed air exits the combustor 17 and expands into the turbine 18, thereby reducing the pressure and temperature of the compressed air and increasing the volume of the compressed air. The airflow through the turbine 18 spins blades that are connected to the shaft 15 through aerodynamic lift. A portion of the shaft power produced by the turbine 18 is used to run the compressor 12 and another portion of the shaft power may be delivered to an electric generator or other load. Remaining thermal energy may be extracted from the exhaust flow by a separate power turbine that in turn is connected to an electric generator or other load.

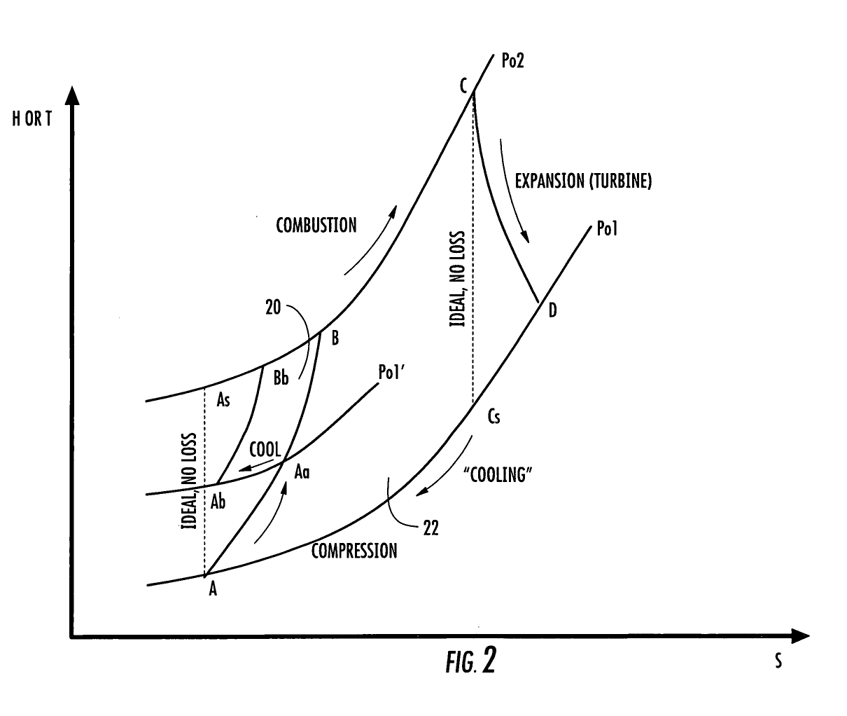

FIG. 2 illustrates an open Brayton cycle graph plotted in terms of Enthalpy/Temperature vs. Entropy for the system illustrated in FIG. 1. The curve Po1 is a constant pressure curve for ambient pressures. The curve Po1′ is a constant pressure curve for intermediate pressure along the compression process. The curve Po2 is a constant pressure curve for pressures at the compressor outlet and turbine inlet.

According to one embodiment of the invention, point A corresponds to ambient pressure and temperature conditions at the inlet to the compressor 12. According to one embodiment of the invention, point Aa corresponds to intermediate pressure and intermediate temperature conditions at an inlet of intercooler 14. According to one embodiment of the invention, point Ab corresponds to intermediate pressure and intermediate temperature conditions at an outlet of intercooler 14. According to one embodiment of the invention, point Bb corresponds to elevated pressure and elevated temperature conditions at the outlet of compressor 12 having a benefit of fluid cooling introduced by the intercooler 14. In particular, the compressor intercooler 14 reduces the compressor 12 discharge temperature compared to point B, which corresponds to elevated pressure and further elevated temperature conditions at the outlet of compressor 12 without the benefit of fluid cooling by the intercooler 14.

According to one embodiment of the invention, point C corresponds to elevated pressure and elevated temperature conditions at the inlet of turbine 18. According to one embodiment of the invention, point D corresponds to ambient pressure and elevated temperature conditions at the outlet of turbine 18.

Due to the addition of the area defined by box 20 onto area defined by box 22, the overall area defined by boxes 20 and 22 is increased when compared to the area defined by box 22 alone. Box 20 signifies the effect of the compressor intercooler 14 on the compressor 12. In particular, the compressor intercooler 14 provides the compressor 12 with higher performance by reducing an amount of work needed to run the compressor 12. The increased overall area contributed by box 20 translates to higher performance of the gas turbine 10.

According to one embodiment of the invention, the compressor intercooler 14 provides improved engine performance and improved cycle performance. According to one embodiment of the invention, the compressor intercooler 14 provides the gas turbine 10 with a power output improvement of between 20 Mega Watts to 30 Mega Watts.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A compressor of a combustion turbine, comprising:
a shell;
a low pressure structure having a plurality of stages within the shell;
a high pressure structure having a plurality of stages within the shell; and
an intercooler that is positioned between the low pressure structure and the high pressure structure comprising:
an inlet that is fluidly coupled to the shell and extracts fluid from at least one stage;
a cooler that is fluidly coupled to the inlet and cools the extracted fluid; and
an outlet that is fluidly coupled to the cooler and returns the cooled fluid to at least one stage.

2. The compressor according to claim 1, further comprising a single shaft that mechanically couples the low pressure structure and the high pressure structure.

3. The compressor according to claim 1, wherein the cooler is a heat exchanger.

4. The compressor according to claim 1, wherein an inlet of the compressor receives ambient air.

5. The compressor according to claim 1, wherein an outlet of the compressor is fluidly coupled to a combustor.

6. The compressor according to claim 1, wherein the at least one stage includes a row of rotating blades and a row of stationary blades.

7. The compressor according to claim 1, wherein the inlet extracts the fluid after a sixth stage of the low pressure structure of the compressor.

8. The compressor according to claim 1, wherein the cooler cools the extracted fluid by at least 25% from an inlet temperature.

9. The compressor according to claim 1, wherein the intercooler extracts substantially 100% all of a total compressor fluid flow.

10. The compressor according to claim 7, wherein the outlet returns the cooled fluid after the sixth stage of the low pressure structure of the compressor.

11. The compressor according to claim 1, wherein the low pressure structure includes a least five stages.

12. The compressor according to claim 1, wherein the high pressure structure includes a least eight stages.

13. A combustion turbine, comprising:
a compressor comprising:
a shell;
a low pressure structure having a plurality of stages within the shell;
a high pressure structure having a plurality of stages within the shell;
an intercooler that is positioned between the low pressure structure and the high pressure structure comprising:
an inlet that is fluidly coupled to the shell and extracts fluid from at least one stage;
a cooler that is fluidly coupled to the inlet and cools the extracted fluid; and
an outlet that is fluidly coupled to the cooler and returns the cooled fluid to at least one stage;
a combustor coupled to the compressor;
a turbine coupled to the combustor; and
a single shaft that mechanically couples the compressor and the turbine.

14. The combustion turbine according to claim 13, wherein the single shaft mechanically couples the low pressure structure, the high pressure structure and the turbine.

15. The combustion turbine according to claim 13, wherein the cooler is a heat exchanger.

16. The combustion turbine according to claim 13, wherein the inlet extracts the fluid after a sixth stage of the low pressure structure of the compressor.

17. The combustion turbine according to claim 13, wherein the cooler cools the extracted fluid by at least 25% from an inlet temperature.

18. The combustion turbine according to claim 13, wherein the intercooler extracts substantially all of a total compressor fluid flow.

19. The combustion turbine according to claim 13, wherein the outlet returns the cooled fluid after the sixth stage of the low pressure structure of the compressor.

20. A compressor of a combustion turbine, comprising:
a shell;
a low pressure structure having a plurality of stages within the shell;
a high pressure structure having a plurality of stages within the shell;
a single shaft that mechanically couples the low pressure structure and the high pressure structure; and
an intercooler that is positioned between the low pressure structure and the high pressure structure comprising:
an inlet that is fluidly coupled to the shell and extracts fluid from at least one stage;
a cooler that is fluidly coupled to the inlet and cools the extracted fluid; and
an outlet that is fluidly coupled to the cooler and returns the cooled fluid to at least one stage.
